(19) United States
(12) Patent Application Publication
(10) Pub. No.: US 2024/0173724 A1
(43) Pub. Date: May 30, 2024

(54) COMPACT BIPOLAR IONIZER

(71) Applicant: Carrier Corporation, Palm Beach Gardens, FL (US)

(72) Inventors: Michael Birnkrant, Manlius, NY (US); Hongsheng Liu, Pudong New Area (CN); Huanan Li, Pudong New Area (CN); Zhiwang Guo, Pudong New Area (CN); Yan Yu, Pudong New Area (CN); Peter McKinney, Boulder, CO (US); Ronghai Hu, Pudong New Area (CN)

(21) Appl. No.: 18/515,506

(22) Filed: Nov. 21, 2023

Related U.S. Application Data
(60) Provisional application No. 63/428,596, filed on Nov. 29, 2022.

(51) Int. Cl. B03C 3/38; B03C 3/41; B03C 3/82

(52) U.S. Cl. CPC B03C 3/38; B03C 3/41; B03C 3/82

(57) ABSTRACT

An electronic air cleaner includes a control housing having an internal cavity, an ion generation power supply arranged within the internal cavity and a brush assembly having at least one electrode directly connected to the ion generation power supply.

### CROSS-REFERENCE TO RELATED APPLICATIONS

This application claims the benefit of U.S. Provisional Application No. 63/428,596, filed Nov. 29, 2022, the contents of which are incorporated by reference herein in their entirety.

### BACKGROUND

Embodiments of the present disclosure relate to the art of air treatment, and more particularly, a cleaning mechanism for cleaning an electronic ionization device.

Air and other fluids are commonly cleaned or purified in a variety of applications. For example, in air conditioning systems, the air to be delivered to an area being conditioned is not only conditioned, but is also filtered or otherwise treated prior to delivery. One device commonly used to perform such treatment is an electronic air cleaner, such as a bipolar ionizer for example. Needlepoint bipolar ionizers generate ions to remove particulate pollution from the air. However, the devices can be large preventing integration with HVAC equipment upstream of the filter.

### BRIEF DESCRIPTION

According to an embodiment, an electronic air cleaner includes a control housing having an internal cavity, an ion generation power supply arranged within the internal cavity and a brush assembly having at least one electrode directly connected to the ion generation power supply.

In addition to one or more of the features described herein, or as an alternative, further embodiments may include the brush assembly including a plurality of electrodes. Each of the plurality of electrodes is directly connected to the ion generation power supply.

In addition to one or more of the features described herein, or as an alternative, further embodiments may include the control housing including a first housing portion and a second housing portion. The second housing portion is connectable to the first housing portion to selectively seal the internal cavity.

In addition to one or more of the features described herein, or as an alternative, further embodiments may include the second housing portion being slidably connectable to the first housing portion.

In addition to one or more of the features described herein, or as an alternative, further embodiments may include the first housing portion further including a first end, and a plurality of sidewalls extending from the first end. At least one opening for receiving the at least one electrode is formed in one of the plurality of sidewalls.

In addition to one or more of the features described herein, or as an alternative, further embodiments may include the at least one opening being formed in a sidewall of the plurality of sidewalls that defines an upper surface of the control housing.

In addition to one or more of the features described herein, or as an alternative, further embodiments may include at least one collar. The at least one electrode is receivable within the at least one collar such that at least a portion of the at least one electrode extends beyond the at least one collar.

In addition to one or more of the features described herein, or as an alternative, further embodiments may include the at least one electrode including between about 24,000 and about 60,000 fibers.

In addition to one or more of the features described herein, or as an alternative, further embodiments may include the at least one electrode including about 48,000 fibers.

In addition to one or more of the features described herein, or as an alternative, further embodiments may include the fibers being silicon carbide.

In addition to one or more of the features described herein, or as an alternative, further embodiments may include the at least one electrode including at least one bristle.

In addition to one or more of the features described herein, or as an alternative, further embodiments may include the at least one electrode including at least one piece having an exposed pointed end.

In addition to one or more of the features described herein, or as an alternative, further embodiments may include a circuit board operably coupled to the ion generation power supply. The circuit board is positioned within the internal cavity.

In addition to one or more of the features described herein, or as an alternative, further embodiments may include the control housing further including a plurality of protrusions arranged within the internal cavity. The plurality of protrusions are arranged in contact with the circuit board to restrict movement of the circuit board within the internal cavity.

In addition to one or more of the features described above, or as an alternative, in further embodiments the control housing further including an engagement feature extending from an interior surface of the control housing. The engagement feature is receivable within a complementary portion of the circuit board.

In addition to one or more of the features described herein, or as an alternative, further embodiments may include a light source operably coupled to the circuit board.

In addition to one or more of the features described herein, or as an alternative, further embodiments may include the control housing further including a logo element. The light source is operable to illuminate the logo element.

In addition to one or more of the features described herein, or as an alternative, further embodiments may include the control housing further including a plurality of feet operable to mount the electronic air cleaner to a duct.

In addition to one or more of the features described herein, or as an alternative, further embodiments may include the plurality of feet being connectable to the duct via a plurality of fasteners.

In addition to one or more of the features described herein, or as an alternative, further embodiments may include the plurality of feet being formed from a magnetic material such that the plurality of feet are magnetically coupled to the duct.

“The foregoing features and elements may be combined in various combinations without exclusivity, unless expressly indicated otherwise. Features which are described in the context of separate aspects and embodiments may be used together and/or be interchangeable. Similarly, features described in the context of a single embodiment may also be provided separately or in any suitable subcombination. These features and elements as well as the operation thereof will become more apparent in light of the following description and the accompanying drawings. It should be understood, however, that the following description and drawings are intended to be illustrative and explanatory in nature and non-limiting.”

### BRIEF DESCRIPTION OF THE DRAWINGS

The following descriptions should not be considered limiting in any way. With reference to the accompanying drawings, like elements are numbered alike:

FIG. 1 is a perspective view of an exemplary electronic air cleaner according to an embodiment;

FIG. 2 is an exploded perspective view of the electronic air cleaner of FIG. 1 according to an embodiment;

FIG. 3 is a front view of a first housing portion of an electronic air cleaner according to an embodiment; and

FIG. 4 is a schematic diagram of an electronic air cleaner according to an embodiment.

### DETAILED DESCRIPTION

A detailed description of one or more embodiments of the disclosed apparatus and method are presented herein by way of exemplification and not limitation with reference to the Figures.

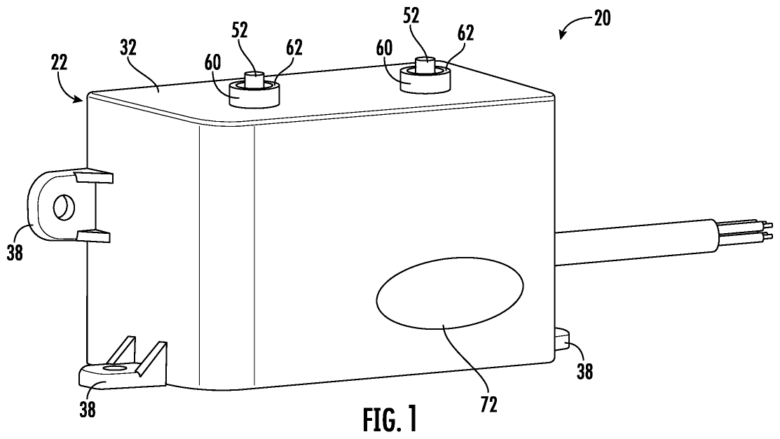

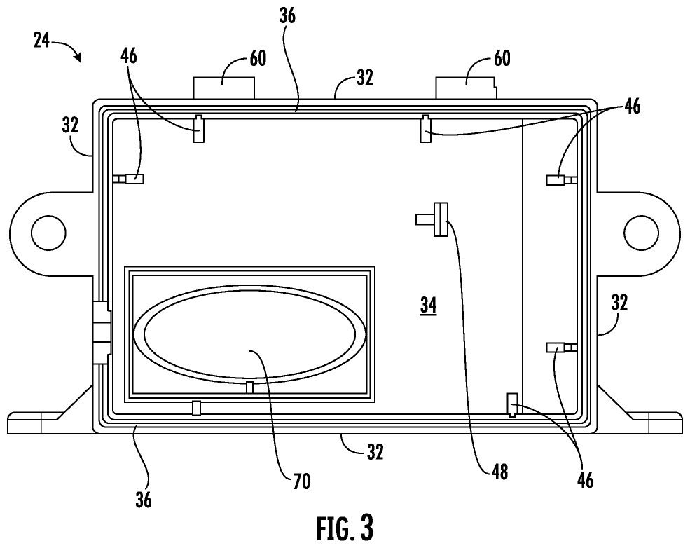

With reference to FIG. 1, an exemplary electronic air cleaner 20 is illustrated. As shown, the air cleaner 20 includes a control housing 22. The control housing 22 may include a first housing portion 24 and a second housing portion 26 removably connectable to the first housing portion 24. In the illustrated, non-limiting embodiment, the first housing portion 24 includes a substantially closed first end 28, an open second end 30, and a plurality of sidewalls 32 extending between the first end 28 and the second end 30 such that a hollow interior or internal cavity 34 (see FIG. 3) is defined therebetween.

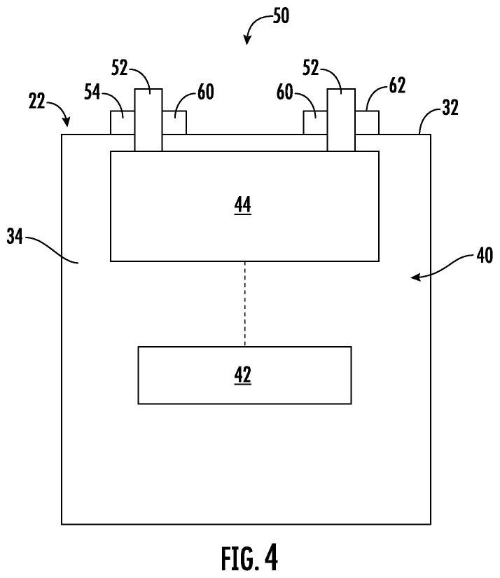

As shown, the second housing portion 26 may be a cover configured to mount to the distal end of the plurality of sidewalls 32 to substantially seal the second open end 30 of the cavity 34. Although the second housing portion 26 is illustrated as having a generally planar configuration, embodiments where the second housing portion 26 has another configuration is also contemplated herein. The second housing portion 26 may be removably coupled to the first housing portion 24, such as via a plurality of fasteners, a snap fit connection, or in any other suitable manner. In an embodiment, the second housing portion 26 is slidably connectable to the first housing portion 24. For example, a track or groove 36 (FIG. 4) may be formed at a distal end of at least one of the sidewalls 32 and the second housing portion 26 is slidably receivable within the groove 36 to couple the second housing portion 26 to the first housing portion 24. Alternatively, the second housing portion 26 may be permanently affixed to the first housing portion 24.

The electronic air cleaner 20 additionally includes an ionizing system 40 (see FIG. 4). In the illustrated, non-limiting embodiment, the ionizing system 40 is arranged within the cavity 34 of the control housing 22. The ionizing system 40 may include a circuit board 42 and an ion generation power supply 44 that is operably coupled to the circuit board 42. As shown in FIG. 4, in an embodiment, one or more protrusions 46 may extend from an interior surface of the sidewalls 32 and/or the first end 28 of the first housing portion 24 to properly position the circuit board 42 within the housing. The plurality of protrusions 46 may abut an end of the circuit board 42 to restrict lateral movement of the circuit board 42 between the sidewalls 32. Alternatively, or in addition, the first housing portion 24 may include at least one engagement feature 48 complementary to and receivable within a corresponding portion, such as an opening or groove (not shown) for example, formed in the circuit board 42 to limit not only lateral movement of the circuit board 42, but also movement between the first end 28 and the second end 30.

The control housing 22, such as the first housing portion 24 thereof for example, may include one or more feet 38 for mounting the air cleaner 20 to a surface of a duct (not shown). In an embodiment, the plurality of feet 38 are eyelets configured to receive fasteners to attach the feet 38 to the duct. Alternatively, the feet 38 may be formed from a magnetic material such that the magnetic attraction between the feet 38 and the duct is sufficient to couple the control housing 22 to the duct.

The ionizing system 40 further includes at least one brush assembly 50 connected to the ion generation power supply 44. In the illustrated, non-limiting embodiment, the at least one brush assembly 50 is directly connected to the ion generation power supply 44. However, embodiments where the at least one brush assembly 50 is directly connected to another component of the ionizing system 40, such as the circuit board 42 for example, are also contemplated herein.

In an embodiment, the at least one brush assembly 50 includes only a single brush assembly. However, embodiments where the at least one brush assembly 50 includes two or more brush assemblies are also contemplated herein. Further, the at least one brush assembly 50 includes at least one electrode or high voltage wire 52 configured to extend through an opening 54 formed in the control housing 22. In an embodiment, the single brush assembly 50 includes two electrodes 52. In such embodiments, each electrode 52 is configured to extend through a respective opening 54 formed in the control housing 22. It should be appreciated that the total number of openings 54 will vary based on the total number of brush assemblies 50 and/or the total number of electrodes 52 associated with each brush assembly 50. In the illustrated, non-limiting embodiment, the openings 54 are formed in a sidewall 32 that defines an upper surface of the control housing 22 when mounted within a duct of an air conditioning system. However, embodiments, where the openings 54 are formed in a sidewall 32 that defines another surface of the control housing 22, such as a lateral side thereof, or a bottom surface thereof for example, are also contemplated herein.

The distance between the openings 54 must be sufficient to prevent interference between the electrodes 52. In an embodiment, the distance between the openings 54 formed in a sidewall 32 of the control housing 22 may be between about 20 mm and about 60 mm, such as between about 30 mm and 50 mm, or in some embodiments about 40 mm.

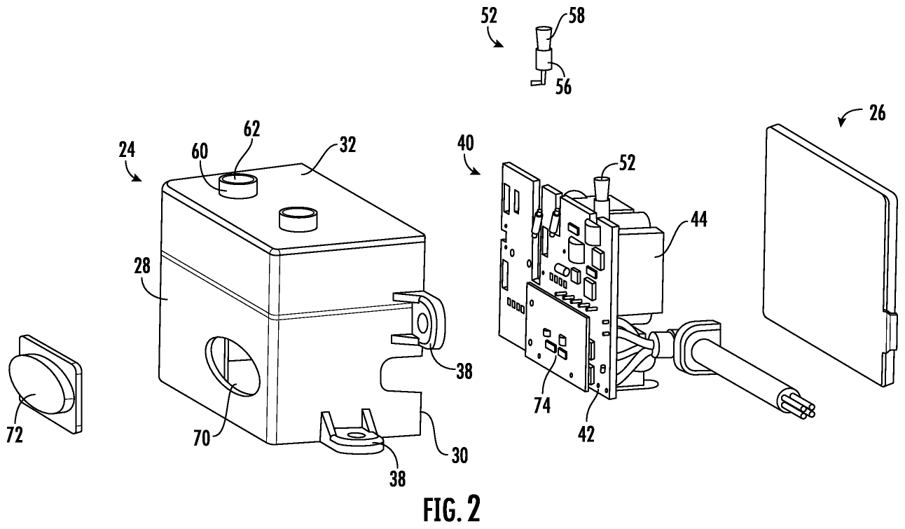

The electrode 52 may contains a brush 56 including at least one bristle. In an embodiment, the at least one bristle includes a plurality of bristles 58 (see FIG. 2) that extend outwardly from a distal end of the brush 56. The brush 56 may be made of any suitable material that conducts electricity. When the electrodes 52 are mounted relative to the control housing 22, the electrodes 52 extend through the openings 54, generally perpendicularly to the sidewall 32. At least one collar 60 may be positioned generally adjacent to the surface of the sidewall 32, coaxially with each opening 54. The collar 60 has a central opening 62 with a diameter generally equal to the diameter of the opening 54 such that a portion of the electrode 52 is receivable therein. The collar 60 may be affixed to the control housing 22 and/or to an electrode 52 in any suitable manner.

In an embodiment, an axial length of the collar 60 extending in a direction parallel to the electrode 52 is selected such that only the distal end of the bristles 58 extend beyond the collar 60. In instances where the electrodes 52 have an elongated configuration, inclusion of a collar 60 provides structural support to the brush 56 to maintain the bristles 58 in a desired position. Further, the collars 60 may help limit the interaction between the adjacent electrodes 52. In an embodiment, the axial length of the collar 60 is between about 2 mm and about 7 mm, such as between about 4 mm and about 6.5 mm, and in some embodiments, is about 5.5 mm.

Because the total number of electrodes 52 of the ionizing system 40 is limited, the ion generation at each electrode 52 may be greater than in systems having several electrodes. In an embodiment, each brush 56, or alternatively each of the electrodes 52, includes a plurality of silicon carbide fibers, such as between about 24,000 and about 60,000 fibers, such as between 35,000 and about 50,000 fibers, and in some embodiments about 48,000 fibers. However, it should be appreciated that a brush 56 including one or more pieces other than bristles that have an exposed sharp or pointed end are within the scope of the disclosure. Further, the sharpness of such pieces may be determined by the voltage of the ionizing system 40.

With continued reference to FIG. 2, in an embodiment, an opening 70 is formed in the first end 28 of the first housing portion 24 and a logo element 72 is arranged within the opening 70. The logo element 72 may be permanently affixed within the opening 70, or may be removably positionable within the opening 70. Further, the logo element 72 may be configured to extend beyond the first end 28 of the first housing portion 24, or alternatively, may be substantially flush with the first end 28. A light source 74, such as a light emitting diode for example, may be operably coupled to the circuit board 42 at a positioned adjacent to the logo element. Accordingly, in an embodiment, the light source is operable to illuminate or provide back lighting to the logo element 72. Illumination of the logo element 72 may also be used to determine that the electronic air cleaner 20 has power.

An electronic air cleaner 20 as illustrated and described herein is compact in size and therefore is suitable for use in small application, such as high wall units for example, to provide air cleaning. Further, because the electrodes are directed connected to the ion generation device 44, the reliability of the air cleaner is increased relative to other air cleaners.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An electronic air cleaner comprising:
a control housing having an internal cavity;
an ion generation power supply arranged within the internal cavity; and
a brush assembly having at least one electrode directly connected to the ion generation power supply.

2. The electronic air cleaner of claim 1, wherein the brush assembly includes a plurality of electrodes, each of the plurality of electrodes being directly connected to the ion generation power supply.

3. The electronic air cleaner of claim 1, wherein the control housing includes a first housing portion and a second housing portion, the second housing portion being connectable to the first housing portion to selectively seal the internal cavity.

4. The electronic air cleaner of claim 3, wherein the second housing portion is slidably connectable to the first housing portion.

5. The electronic air cleaner of claim 3, wherein the first housing portion further comprises a first end, and a plurality of sidewalls extending from the first end, wherein at least one opening for receiving the at least one electrode is formed in one of the plurality of sidewalls.

6. The electronic air cleaner of claim 5, wherein the at least one opening is formed in a sidewall of the plurality of sidewalls that defines an upper surface of the control housing.

7. The electronic air cleaner of claim 1, further comprising at least one collar, the at least one electrode being receivable within the at least one collar such that at least a portion of the at least one electrode extends beyond the at least one collar.

8. The electronic air cleaner of claim 1, wherein the at least one electrode includes between about 24,000 and about 60,000 fibers.

9. The electronic air cleaner of claim 8, wherein the at least one electrode includes about 48,000 fibers.

10. The electronic air cleaner of claim 8, wherein the fibers are silicon carbide.

11. The electronic air cleaner of claim 1, wherein the at least one electrode includes at least one bristle.

12. The electronic air cleaner of claim 1, wherein the at least one electrode includes at least one piece having an exposed pointed end.

13. The electronic air cleaner of claim 1, further comprising a circuit board operably coupled to the ion generation power supply, the circuit board being positioned within the internal cavity.

14. The electronic air cleaner of claim 13, wherein the control housing further comprises a plurality of protrusions arranged within the internal cavity, the plurality of protrusions being arranged in contact with the circuit board to restrict movement of the circuit board within the internal cavity.

15. The electronic air cleaner of claim 13, wherein the control housing further comprises an engagement feature extending from an interior surface of the control housing, the engagement feature being receivable within a complementary portion of the circuit board.

16. The electronic air cleaner of claim 13, further comprising a light source operably coupled to the circuit board.

17. The electronic air cleaner of claim 16, wherein the control housing further comprises a logo element, and the light source is operable to illuminate the logo element.

18. The electronic air cleaner of claim 1, wherein the control housing further comprises a plurality of feet operable to mount the electronic air cleaner to a duct.

19. The electronic air cleaner of claim 18, wherein the plurality of feet are connectable to the duct via a plurality of fasteners.

20. The electronic air cleaner of claim 18, wherein the plurality of feet are formed from a magnetic material such that the plurality of feet are magnetically coupled to the duct.
